(19) United States
(12) Patent Application Publication
(10) Pub. No.: US 2021/0232790 A1
(43) Pub. Date: Jul. 29, 2021

(54) FINGERPRINT IDENTIFICATION TOUCH PANEL, MANUFACTURING METHOD THEREOF AND DISPLAY DEVICE

(71) Applicants: Hefei BOE Optoelectronics Technology Co., Ltd., Hefei, Anhui (CN); BOE TECHNOLOGY GROUP CO., LTD., Beijing (CN)

(72) Inventors: Lei ZHANG, Beijing (CN); Junsheng CHEN, Beijing (CN); Hongmin LI, Beijing (CN)

(21) Appl. No.: 17/256,139

(22) PCT Filed: Jun. 8, 2020
(86) PCT No.: PCT/CN2020/094901

§ 371 Date: Dec. 24, 2020

(30) Foreign Application Priority Data
Jun. 14, 2019 (CN) 201910515710.0

(51) Int. Cl. G06K 9/00; G02F 1/1333; G06F 3/041; G06F 3/044; G02F 1/1335

(52) U.S. Cl. CPC G06K 9/0002; G02F 1/13338; G02F 1/133531; G06F 3/0446; G06F 3/0412

(57) ABSTRACT

The present disclosure provides a fingerprint identification touch panel and a display device and belongs to the field of display technology. The fingerprint identification touch panel includes: a fingerprint identification substrate disposed on a side of light-exiting surface of a display module; and a fingerprint identification chip configured to be electrically coupled with the fingerprint identification substrate and to identify fingerprint information according to a detection signal of the fingerprint identification substrate, where an orthographic projection of the fingerprint identification substrate on the display module does not overlap an orthographic projection of the fingerprint identification chip on the display module.

### CROSS REFERENCE TO RELATED APPLICATIONS

This application claims priority to Chinese patent application No. 201910515710.0 filed with the Chinese Intellectual Property Office on Jun. 14, 2019, the entire contents of which are incorporated herein by reference.

### TECHNICAL FIELD

The present disclosure relates to the field of display technology, and particularly relates to a fingerprint identification touch panel, a manufacturing method of the fingerprint identification touch panel and a display device.

### BACKGROUND

With the development of multimedia technology, portable electronic devices such as smart phones and tablet computers have become essential tools in people's lives, and important personal information of users is often stored in the portable electronic devices. Therefore, certain authentication and authority management measures are necessary for the products in use to protect the information stored therein so as to prevent the personal information of the users from being leaked or stolen carelessly.

Among identity authentication methods in the related art, fingerprint identification is an advanced and widely used method. Because the fingerprint of each person is unique, the fingerprint identification and authentication method has high safety and is convenient to be used.

### SUMMARY

An embodiment of the present disclosure provides a fingerprint identification touch panel, including: a display module; a fingerprint identification substrate disposed on a side of light-exiting surface of the display module; and a fingerprint identification chip configured to be electrically coupled with the fingerprint identification substrate and to identify fingerprint information according to a detection signal of the fingerprint identification substrate, where, an orthographic projection of the fingerprint identification substrate on the display module does not overlap an orthographic projection of the fingerprint identification chip on the display module.

In some implementations, the fingerprint identification substrate includes: a first base; and a plurality of fingerprint identification units on the first base, each of the fingerprint identification units includes a driving electrode and a sensing electrode arranged side by side, the driving electrode is configured to receive a driving signal; the sensing electrode is configured to sense change of capacitance between the sensing electrode and the driving electrode as the detection signal in a fingerprint identification stage.

In some implementations, the fingerprint identification substrate further includes: a plurality of scanning lines and a plurality of reading lines; the plurality of scanning lines and the plurality of reading lines are arranged in an intersecting manner to define the fingerprint identification units; where, driving electrodes in the fingerprint identification units in a same row are coupled with a same one of the scanning lines; sensing electrodes in the fingerprint identification units in a same column are coupled with a same one of the reading lines.

In some implementations, the fingerprint identification substrate further includes: a flexible circuit board on which the fingerprint identification chip is located, and where, the scanning lines and the reading lines are bound and coupled with the flexible circuit board, so that the scanning lines and the reading lines are electrically coupled with the fingerprint identification chip.

In some implementations, the fingerprint identification substrate has a resolution ranging from 200 ppi to 400 ppi.

In some implementations, each of the fingerprint identification units has a size ranging from 80 μm to 200 μm.

In some implementations, a total area of the fingerprint identification units ranges from 4 mm×4 mm to 10 mm×10 mm.

In some implementations, a material of the first base includes glass. In some implementations, the display module includes a first substrate and a second substrate which are arranged oppositely; where the first substrate includes a first base substrate, and the first base substrate serves as the first base.

In some implementations, the display module includes a first substrate and a second substrate, which are arranged oppositely; where the first substrate includes: a first base substrate, and where, the first base substrate is bonded to the first base through a first bonding layer.

In some implementations, a material of the first bonding layer includes any one of transparent optical conductive adhesive, optical liquid adhesive and frame adhesive.

In some implementations, the fingerprint identification touch panel further includes a cover plate located on a side of the fingerprint identification substrate away from the display module.

In some implementations, the fingerprint identification touch panel further includes: an upper polarizer disposed on the side of light-exiting surface of the display module; where, the upper polarizer serves as the cover plate.

In some implementations, the cover plate is bonded to the fingerprint identification substrate by a second bonding layer.

In some implementations, a material of the second bonding layer includes any one of transparent optical conductive adhesive, optical liquid adhesive and frame adhesive.

In some implementations, the display module includes a liquid crystal module.

An embodiment of the present disclosure provides a display device, which includes the fingerprint identification touch panel described above.

An embodiment of the present disclosure provides a method of manufacturing the fingerprint identification touch panel described above, which includes:

forming the fingerprint identification substrate on the side of light-exiting surface of the display module;

electrically coupling the fingerprint identification substrate to the fingerprint identification chip.

In some implementations, the fingerprint identification substrate includes a first base and a plurality of fingerprint identification units on the first base, and where forming the fingerprint identification substrate on the side of light-exiting surface of the display module further includes:

forming the first base on the side of light-exiting surface of the display module;

forming the plurality of fingerprint identification units on a surface of the first base away from the display module, each of the fingerprint identification units includes the driving electrode and the sensing electrode arranged side by side.

In some implementations, the fingerprint identification substrate further includes: a plurality of scanning lines and a plurality of reading lines; the plurality of scanning lines and the plurality of reading lines are arranged in an intersecting manner to define the fingerprint identification units, and the method further includes the following steps:

forming the plurality of scanning lines and the plurality of reading lines on the surface of the first base away from the display module, where

the driving electrodes in the fingerprint identification units in a same row are coupled with a same one of the scanning lines;

the sensing electrodes in the fingerprint identification units in a same column are coupled with a same one of the reading lines.

In some implementations, the method further includes: electrically coupling the scanning lines and the reading lines with the fingerprint identification chip.

### DESCRIPTION OF DRAWINGS

FIG. 1 is a schematic structural diagram of a fingerprint identification touch panel according to an embodiment of the present disclosure;

FIG. 2 is a schematic diagram of arrangement of fingerprint identification units according to an embodiment of the present disclosure.

FIG. 3 is a flowchart of manufacturing a fingerprint identification touch panel according to an embodiment of the present disclosure.

### DESCRIPTION OF EMBODIMENTS

In order that those skilled in the art will better understand the technical solutions of the present disclosure, the following detailed description is given with reference to the accompanying drawings and the specific embodiments.

Unless defined otherwise, technical or scientific terms used herein shall have the ordinary meaning as understood by one of ordinary skill in the art to which this disclosure belongs. The use of “first”, “second” and the like in this disclosure is not intended to indicate any order, quantity, or importance, but rather is used to distinguish one element from another. Also, the use of the terms “a”, “an” or “the” and similar referents do not denote a limitation of quantity, but rather denote the presence of at least one. The word “comprising/including” or “comprises/includes”, and the like, means that the element or item preceding the word comprises the element or item listed after the word and its equivalent, but does not exclude other elements or items. The terms “connected” or “coupled” and the like are not restricted to physical or mechanical connections, but may include electrical connections, whether direct or indirect. “Up”, “low”, “left”, “right”, and the like are used only to indicate relative positional relationships, and when the absolute position of the object being described is changed, the relative positional relationships may also be changed accordingly.

An embodiment of the present disclosure provides a fingerprint identification touch panel, which includes a display module and a fingerprint identification substrate located on a side of light-exiting surface of the display module; the display module may be a liquid crystal module or an organic light emitting diode display module, and in the following embodiments, the display module mainly adopts a liquid crystal module for illustration.

The liquid crystal module specifically includes a first substrate and a second substrate which are oppositely arranged; the first substrate may be a color filter substrate, and the second substrate may be an array substrate; certainly, the first substrate may be an opposite substrate, and the second substrate may be a COA (Color On Array; a color filter is disposed on the array substrate) substrate, and in the following embodiments, for example, the first substrate is a color filter substrate, and the second substrate is an array substrate.

Certainly, the liquid crystal module in the present embodiment may be a display module having a touch function, for example, the liquid crystal module may be a self-capacitance touch module or a mutual capacitance touch module.

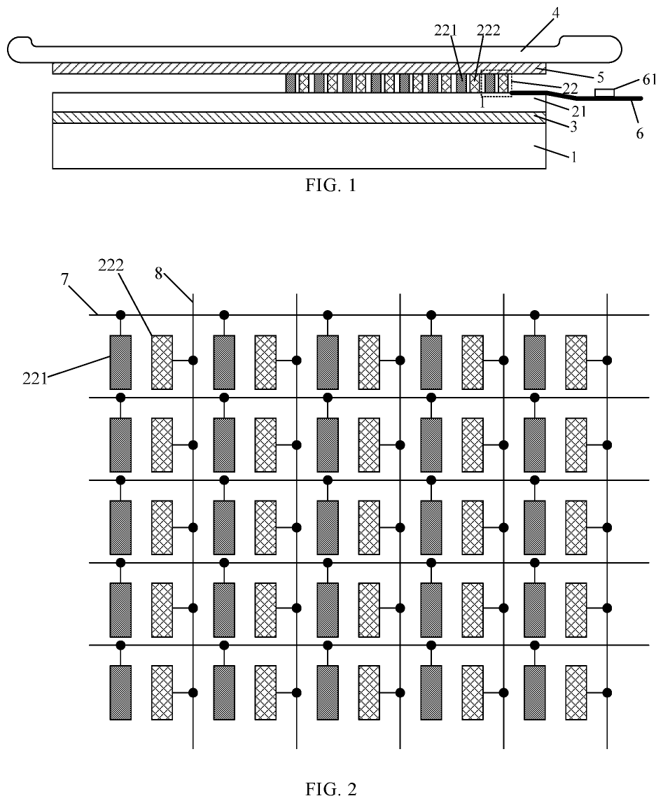

As shown in FIG. 1, an embodiment of the present disclosure provides a fingerprint identification touch panel, including a liquid crystal module 1 and a fingerprint identification substrate located on a side of light-exiting surface of the liquid crystal module 1; where, the fingerprint identification substrate includes: a first base 21, a plurality of fingerprint identification units 22 disposed on the first base 21; each of the fingerprint identification units 22 includes a driving electrode 221 and a sensing electrode 222 disposed side by side on the first base 21; the driving electrode 221 is used for receiving a driving signal; the sensing electrode 222 is used for sensing a capacitance change between the driving electrode 221 and the sensing electrode 222 in a fingerprint identification stage for performing fingerprint identification.

Since the touch panel of the present embodiment has the fingerprint identification substrate disposed on the side of light-exiting surface side of the liquid crystal module 1, and each of the touch unit in the fingerprint identification substrate includes the driving electrode 221 and the sensing electrode 222 disposed side by side, in this way, when a touch object (for example, a finger) touches the touch panel, in the fingerprint identification stage, a signal on the corresponding sensing electrode 222, which is coupled by the driving signal output to each driving electrode 221 through the valleys and the ridges of the finger fingerprint from the driving signal output to each driving electrode 221, will change, and at this time, the fingerprint information can be determined by detecting the charge variation (i.e., capacitance variation,) between the driving electrode 221 and the sensing electrode 222, that is, the capacitance variation, so as to complete the identification of the fingerprint.

As shown in FIG. 2, the fingerprint identification substrate not only includes the above structure, but also includes a plurality of scanning lines 7 and a plurality of reading lines 8, and the plurality of scanning lines 7 and the plurality of reading lines 8 are arranged in an intersecting manner and define the fingerprint identification units 22; in this case, the driving electrodes 221 in the fingerprint identification units 22 in a same row are coupled to a same one of the scanning lines 7, and the sensing electrodes 222 in the fingerprint identification units 22 in a same column are coupled to a same one of the reading lines 8.

Specifically, in the fingerprint identification stage, driving signals are input to the scanning lines 7 line by line, and an amount of charge induced on the sensing electrode 222 is read through the reading line 8, so that a fingerprint identification chip 61 determines the capacitance between the driving electrode 221 and the sensing electrode 222 of the fingerprint identification unit 22 according to the change of charge induced by the sensing electrode 222, so as to identify the fingerprint information.

Furthermore, the fingerprint identification substrate in the present embodiment further includes a flexible printed circuit board 6, and the fingerprint identification chip 61 is disposed on the flexible printed circuit board 6; the scanning lines and the reading lines are bound and coupled with the flexible circuit board 6, so that the scanning lines 7 and the reading lines 8 are electrically coupled with the fingerprint identification chip 61. The flexible printed circuit board 6 may be disposed in a peripheral region outside a touch region of the touch panel, for example, an orthogonal projection of the fingerprint identification substrate on the liquid crystal module does not overlap an orthogonal projection of the fingerprint identification chip on the liquid crystal module.

Specifically, first connection pads should be disposed on the first base 21, the first connection pads are coupled to the corresponding scanning lines and the corresponding reading lines, respectively, second connection pads are disposed on the flexible circuit board 6, and the second connection pads are coupled to pins of the fingerprint identification chip 61 through signal connection lines; in this case, the electrical coupling of the scanning lines and the reading lines to the fingerprint identification chip 61 can be completed by bonding and coupling the first connection pads and the second connection pads.

An image processing unit and an image comparison unit may be integrated in the fingerprint identification chip 61; the image processing unit can determine the fingerprint information according to the change of charge induced on the sensing electrode 222 read by the reading line, and then input the fingerprint information into the image comparison unit, and the image comparison unit compares the fingerprint information with a standard fingerprint information pre-stored therein and outputs a comparison result to a central processing unit of the touch panel, so as to control the touch panel to execute corresponding commands according to the comparison result. For example, when the fingerprint information matches with the standard fingerprint information, an unlock function of the touch panel may be implemented.

In the present embodiment, a resolution of the fingerprint identification substrate may range from 200 ppi to 400 ppi. An area of each fingerprint identification unit 22 may range from 80 μm to 200 μm. A total area of all the fingerprint identification units 22 may range from 4 mm×4 mm to 10 mm×10 mm, and specifically may be 8 mm×8 mm. The total area of the fingerprint identification units 22 in the present embodiment is larger than that of the related art, so that the resolution of the fingerprint identification substrate can be relatively reduced, and in this case, the area of each fingerprint identification unit 22 can be made large, so that a penetrating thickness of the fingerprint identification unit 22 can reach more than 0.4 mm, and the accuracy of fingerprint identification is greatly improved. Matching settings (each column in a group) of resolutions, sizes (e.g., lengths) of the fingerprint identification units 22, and matrix sizes of the fingerprint identification units 22 of several fingerprint identification substrates are given below, as shown in table 1.

TABLE 1

| Resolution | 127 ppi | 200 ppi | 142 ppi | 250 ppi | 170 ppi | 300 ppi |
|---|---|---|---|---|---|---|
| Size | 200 μm | 127 μm | 178.5 μm | 101.6 μm | 150 μm | 84.66 μm |
| Matrix size | 20 × 20 | 32 × 32 | 23 × 23 | 40 × 40 | 27 × 27 | 48 × 48 |

The material of the first base 21 in the present embodiment includes glass, that is, the first base 21 is a glass base. The glass base in the present embodiment is lower in cost than the silicon-based base in the fingerprint identification substrate in the related art.

The fingerprint identification substrate in the present embodiment may be bonded with display module 1 through a first bonding layer 3.

Specifically, the first base in the fingerprint identification substrate and a first base substrate of a color filter substrate in the liquid crystal module 1 are bonded together through a first bonding layer 3; a material of the first bonding layer 3 includes any one of transparent optical conductive adhesive (OCA), optical liquid adhesive (OCR) and frame adhesive. Certainly, other transparent adhesives may be used to bond the first base substrate to the first base 21 to complete the bonding between the fingerprint identification substrate and the display module.

Certainly, in some implementations, the first base substrate in the color filter substrate of the liquid crystal module 1 may be multiplexed as the first base 21, that is, the fingerprint identification units 22 are formed on a side of the first base substrate of the color filter substrate away from the color filter layer. Therefore, the touch panel is light and thin.

The touch panel of the present embodiment not only includes the above structure, but also includes a cover plate 4 disposed on a side of the fingerprint identification units 22 away from the first base 21.

In some implementations, it is common for the liquid crystal display device to include an upper polarizer on the side of light-exiting surface of the liquid crystal module 1, and the upper polarizer is multiplexed as the cover plate 4 in the present embodiment. Reasons for such arrangement are as follows: in the present embodiment, the fingerprint identification unit 22 is formed by the driving electrode 221 and the sensing electrode 222 which are arranged side by side between the first base 21 and the cover plate 4, and the penetrating thickness of the fingerprint identification unit 22 with such a structure is large, so that a thick upper polarizer can be used as the cover plate 4.

In the present embodiment, the cover plate 4 may be bonded to the fingerprint identification substrate through a second bonding layer 5; a material of the second bonding layer 5 includes any one of transparent optical conductive adhesive (OCA), optical liquid adhesive (OCR) and frame adhesive. Certainly, other transparent adhesives may be used to bond the cover plate 4 to the fingerprint identification substrate.

In the touch panel of the present embodiment, the fingerprint identification units (touch sensors) are separated from the fingerprint identification chip, so that an identification area of the fingerprint identification unit can be increased, a large identification penetrating thickness is realized, and meanwhile, the area of the fingerprint identification chip can be greatly reduced, thereby reducing the cost.

An embodiment of the present disclosure provides a display device, which includes the fingerprint identification touch panel in the foregoing embodiment, and therefore, the display device can implement a fingerprint identification function.

The display device may be any product or component with a display function, such as a liquid crystal panel, electronic paper, an OLED panel, a mobile phone, a tablet computer, a television, a display, a notebook computer, a digital photo frame, a navigator and the like.

In the display device in the present embodiment, the fingerprint identification units (touch sensors) are separated from the fingerprint identification chip, so that the identification area of the fingerprint identification unit can be increased, a large identification penetrating thickness is realized, meanwhile, the area of the fingerprint identification chip can be greatly reduced, and the cost is reduced.

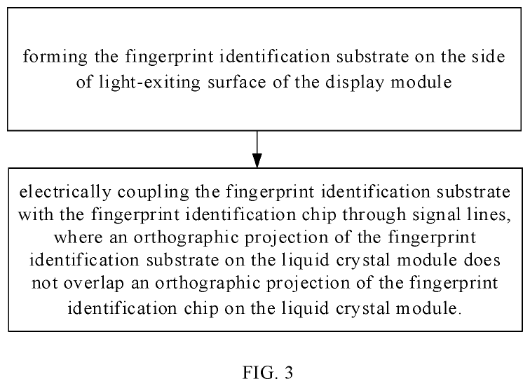

An embodiment of the present disclosure provides a method of manufacturing a touch panel with a fingerprint identification function, where the touch panel with the fingerprint identification function is the touch panel in the above embodiment, and with reference to FIG. 1 and FIG. 3, the method of manufacturing the touch panel includes:

forming a fingerprint identification substrate on a side of light-exiting surface of the liquid crystal module 1; and

electrically coupling the fingerprint identification substrate with the fingerprint identification chip through signal lines, where an orthographic projection of the fingerprint identification substrate on the liquid crystal module does not overlap an orthographic projection of the fingerprint identification chip on the liquid crystal module.

In some implementations, the fingerprint identification substrate includes: a first base 21 and a plurality of fingerprint identification units 22 on the first base 21, where forming the fingerprint identification substrate on the side of light-exiting surface of the liquid crystal module 1 further includes:

forming the first base 21 on the side of light-exiting surface of the liquid crystal module 1;

forming the fingerprint identification units 22 on a surface of the first base 21 away from the liquid crystal module 1, where each fingerprint identification unit 22 includes a driving electrode 221 and a sensing electrode 222 which are arranged side by side.

The fingerprint identification substrate further includes: a plurality of scanning lines 7 and a plurality of reading lines 8; the scanning lines 7 and the reading lines 8 are arranged in an intersecting manner to define the fingerprint identification units, and the method further includes the following steps:

forming the plurality of scanning lines 7 and the plurality of reading lines 8 on the surface of the first base 21 away from the liquid crystal module, where,

the driving electrodes in the fingerprint identification units in a same row are coupled with a same one of the scanning lines 7;

the sensing electrodes in the fingerprint identification units in a same column are coupled with a same one of the reading lines 8.

The method further includes: electrically coupling the scanning lines 7 and the reading lines 8 with the fingerprint identification chip.

In some implementations, the method of manufacturing the touch panel further includes: forming a cover plate 4 on a side of the fingerprint identification units away from the first base 21, where the cover plate 4 is bonded to the fingerprint identification substrate through a second bonding layer 5.

In the touch panel manufactured by the above method in the embodiment, the fingerprint identification units (touch sensors) are separated from the fingerprint identification chip, so that the identification area of the fingerprint identification unit can be increased, a large identification penetrating thickness is realized, meanwhile, the area of the fingerprint identification chip can be greatly reduced, and the cost is reduced.

It will be understood that the above embodiments are merely exemplary embodiments employed to illustrate the principles of the present disclosure, and the present disclosure is not limited thereto. It will be apparent to those skilled in the art that various changes and modifications can be made therein without departing from the spirit and scope of the present disclosure, and these changes and modifications are to be considered within the scope of the present disclosure.

1. A fingerprint identification touch panel, comprising:
a display module;
a fingerprint identification substrate disposed on a side of light-exiting surface of the display module; and
a fingerprint identification chip configured to be electrically coupled with the fingerprint identification substrate and to identify fingerprint information according to a detection signal of the fingerprint identification substrate,
wherein, an orthographic projection of the fingerprint identification substrate on the display module does not overlap an orthographic projection of the fingerprint identification chip on the display module.

2. The fingerprint identification touch panel of claim 1, wherein the fingerprint identification substrate comprises: a first base; and a plurality of fingerprint identification units on the first base, each of the fingerprint identification units comprises a driving electrode and a sensing electrode arranged side by side,
the driving electrode is configured to receive a driving signal;
the sensing electrode is configured to sense change of capacitance between the sensing electrode and the driving electrode as the detection signal in a fingerprint identification stage.

3. The fingerprint identification touch panel of claim 2, wherein the fingerprint identification substrate further comprises: a plurality of scanning lines and a plurality of reading lines; the plurality of scanning lines and the plurality of reading lines are arranged in an intersecting manner to define the fingerprint identification units; wherein,
driving electrodes in the fingerprint identification units in a same row are coupled with a same one of the scanning lines;
sensing electrodes in the fingerprint identification units in a same column are coupled with a same one of the reading lines.

4. The fingerprint identification touch panel of claim 3, wherein the fingerprint identification substrate further comprises: a flexible circuit board on which the fingerprint identification chip is located, and wherein,
the scanning lines and the reading lines are bound and coupled with the flexible circuit board, so that the scanning lines and the reading lines are electrically coupled with the fingerprint identification chip.

5. The fingerprint identification touch panel of claim 1, wherein the fingerprint identification substrate has a resolution ranging from 200 ppi to 400 ppi.

6. The fingerprint identification touch panel of claim 1, wherein each of the fingerprint identification units has a size ranging from 80 μm to 200 μm.

7. The fingerprint identification touch panel of claim 1, wherein a total area of the fingerprint identification units ranges from 4 mm×4 mm to 10 mm×10 mm.

8. The fingerprint identification touch panel of claim 1, wherein a material of the first base comprises glass.

9. The fingerprint identification touch panel of claim 2, wherein the display module comprises a first substrate and a second substrate which are arranged oppositely; wherein the first substrate comprises a first base substrate, and the first base substrate serves as the first base.

10. The fingerprint identification touch panel of claim 2, wherein the display module comprises a first substrate and a second substrate which are arranged oppositely; wherein the first substrate comprises: a first base substrate, and wherein, the first base substrate is bonded to the first base through a first bonding layer.

11. The fingerprint identification touch panel of claim 10, wherein a material of the first bonding layer comprises any one of transparent optical conductive adhesive, optical liquid adhesive and frame adhesive.

12. The fingerprint identification touch panel of claim 1, further comprising a cover plate located on a side of the fingerprint identification substrate away from the display module.

13. The fingerprint identification touch panel of claim 12, further comprising: an upper polarizer disposed on the side of light-exiting surface of the display module; wherein, the upper polarizer serves as the cover plate.

14. The fingerprint identification touch panel of claim 12, wherein the cover plate is bonded to the fingerprint identification substrate by a second bonding layer.

15. The fingerprint identification touch panel of claim 14, wherein a material of the second connection layer comprises any one of transparent optical conductive adhesive, optical liquid adhesive and frame adhesive.

16. The fingerprint identification touch panel of claim 1, wherein the display module is a liquid crystal module.

17. A display device, comprising the fingerprint identification touch panel of claim 1.

18. A method of manufacturing the fingerprint identification touch panel according to claim 1, comprising:
forming the fingerprint identification substrate on the side of light-exiting surface of the display module;
electrically coupling the fingerprint identification substrate to the fingerprint identification chip.

19. The method of claim 18, wherein the fingerprint identification substrate comprises a first base and a plurality of fingerprint identification units on the first base, and wherein
forming the fingerprint identification substrate on the side of light-exiting surface of the display module further comprises:
forming the first base on the side of light-exiting surface of the display module;
forming the plurality of fingerprint identification units on a surface of the first base away from the display module, each of the fingerprint identification units comprises a driving electrode and a sensing electrode arranged side by side.

20. The method of claim 19, wherein the fingerprint identification substrate further comprises: a plurality of scanning lines and a plurality of reading lines; the plurality of scanning lines and the plurality of reading lines are arranged in an intersecting manner to define the fingerprint identification units, and the method further comprises:
forming the plurality of scanning lines and the plurality of reading lines on the surface of the first base away from the display module, wherein
driving electrodes in the fingerprint identification units in a same row are coupled with a same one of the scanning lines,
sensing electrodes in the fingerprint identification units in a same column are coupled with a same one of the reading lines; and
electrically coupling the scanning lines and the reading lines with the fingerprint identification chip.

21. (canceled)
